(19) United States
(12) Patent Application Publication
(10) Pub. No.: US 2007/0186231 A1
(43) Pub. Date: Aug. 9, 2007

(54) System and method for controlling settings for television services

(75) Inventors: Anthony Haeuser, Aurora, IL (US); Mary McCarthy, San Antonio, TX (US); Scott Pettit, San Antonio, TX (US); Christopher A. Lee, San Antonio, TX (US); Ross Cox, Cumming, GA (US)

Correspondence Address: PAUL S MADAN;MADAN, MOSSMAN & SRIRAM, PC, 2603 AUGUSTA, SUITE 700, HOUSTON, TX, 77057-1130, US

(73) Assignee: SBC Knowledge Ventures L.P., Reno, NV (US)

(21) Appl. No.: 11/346,646

(22) Filed: Feb. 3, 2006

(51) Int. Cl. H04N 7/16; G06F 13/00; H04N 7/173; H04N 7/18; H04N 5/445; G06F 3/00

(52) U.S. Cl. 725/25; 725/56; 725/39; 725/30; 725/80; 725/109; 725/112; 725/45

(57) ABSTRACT

The present disclosure provides a system and method that enables a customer to create a favorite list of channels for a main programming list of channels and switch between the favorite list and the main programming list and block any channel on either of the lists.

### BACKGROUND OF THE DISCLOSURE

1. Field of the Disclosure

The present disclosure relates generally to the provision of television services over a television network.

2. Background

Television services provided over a television network, such as an Internet Protocol Television (IPTV) network, cable network or satellite network, include various content such as content over multiple channels, Video-on-Demand (VoD), Voice over Internet Protocol (VoIP), data from the Internet, etc., to customers over a broadband connection. The broadband connection typically terminates at a Set Top Box (STB) located at a customer premise. The STB may be coupled to a television set as well as to additional devices, such as a Digital Video Recorder (DVR). A DVR is a device that records video to a digital storage medium, such as a hard disk, in digital form, thereby enabling a viewer to record a show at a given time to be played back at another time, pause live TV shows, and skip advertising, among other things. In addition to the multiple content available, IPTV provides various features to a customer's viewing experience, such as an ability to purchase items through a television set, an integration of television viewing and Internet usage, interactive games, etc.

The STB typically operates a set of features which affect the viewer experience. Some typical features include parental control settings that enable a customer (also referred herein as “supervisor”) to restrict the content that may be viewed at a customer location. Often, a customer may have several STBs each controlling a separate television. Each STB typically has a separate identifier and may be controlled by a separate personal identifier number (PIN).

Current television systems typically deliver hundreds of channels to STBs, and viewers typically navigate through many channels or groups of channels to select a channel to view. Also, such systems do not provide adequate capability to create and control personalized lists of channels or content for the master and sub-accounts. Thus, there is a need to provide an improved system and method that addresses at least some of the abovementioned problems.

### BRIEF DESCRIPTION OF THE DRAWINGS

For detailed understanding of the present disclosure, references should be made to the following detailed description of an exemplary embodiment, taken in conjunction with the accompanying drawings, in which like elements have been given like numerals, wherein:

FIG. 1 shows an exemplary high level functional diagram of a network for providing Internet Protocol Television (IPTV) services according to one embodiment of the present disclosure;

FIG. 2 illustrates an exemplary screenshot displaying options available to a supervisor through an interface accessible by a Set Top Box (STB) or a remote device;

FIG. 3 illustrates an exemplary screenshot for making changes to parental control settings;

FIG. 4 shows an exemplary screenshot of parental control settings of an individual account;

FIG. 5 shows an exemplary screenshot of a main programming guide;

FIG. 6 shows an exemplary screenshot of a Favorites list as seen on a television set without parental control settings;

FIG. 7 shows an exemplary screenshot of a Favorites list with parental control settings applied; and

FIG. 8 is a diagrammatic representation of a machine in the form of a computer system within which a set of instructions, when executed, may cause the machine to perform any one or more of the methodologies discussed herein.

### DETAILED DESCRIPTION OF THE DISCLOSURE

In view of the above, the present disclosure through one or more of its various aspects and/or embodiments is presented to provide one or more advantages, such as those noted below.

The present disclosure provides a system, method and computer programs for the provision of content over a telecommunication network. In one aspect, the disclosure provides a computer-readable medium that contains a computer program that has instructions to provide a first list of channels; instructions to create a second list from the first list in response to input from a customer device; and instructions to switch between display of the first and second lists in response to an input. The computer program may include instructions to block one or more channels on the first list. In one aspect, the computer program includes instructions that automatically block a channel from viewing from the second list if that channel is blocked on the first list. In another aspect, the computer program includes instructions to alter channels in the second list and block selected channels in the first and second lists in response to input from a remote device over a communication network.

In another aspect, the disclosure provides a method that provides a set of channels for viewing on a television set; enables a customer to create a favorite list from the set of channels; and enables the customer to switch between the set of channels and the favorite list.

In yet another aspect, the disclosure provides a network that includes a backbone that transmits a set of channels to a customer premise device for display on a television set. A computer program that enables the customer to create a subset of channels from the set of channels and to switch between the set of channels and subsets of channels. The computer program further may include instructions that block selected channels in the set of channels and automatically block such selected channels on the subset of channels. In yet another aspect, the disclosure provides a device for use with a television set that includes a computer program that has instructions to receive a set of channels from a communications network and to display such channels; instructions to receive input to create a second set of channels from the first set or list of channels; and instructions to switch between the two sets of channels in response to an input. The device further may include a remote control device that has a switch or an input mechanism for providing the input to the device for changing between the two sets of channels. In another aspect, the device may include programs that enable creating of multiple lists of channels and allow switching among the multiple channels. The program may further include instructions to block one or more channels on one list instructions that automatically block such channels on one or more selected lists of channels.

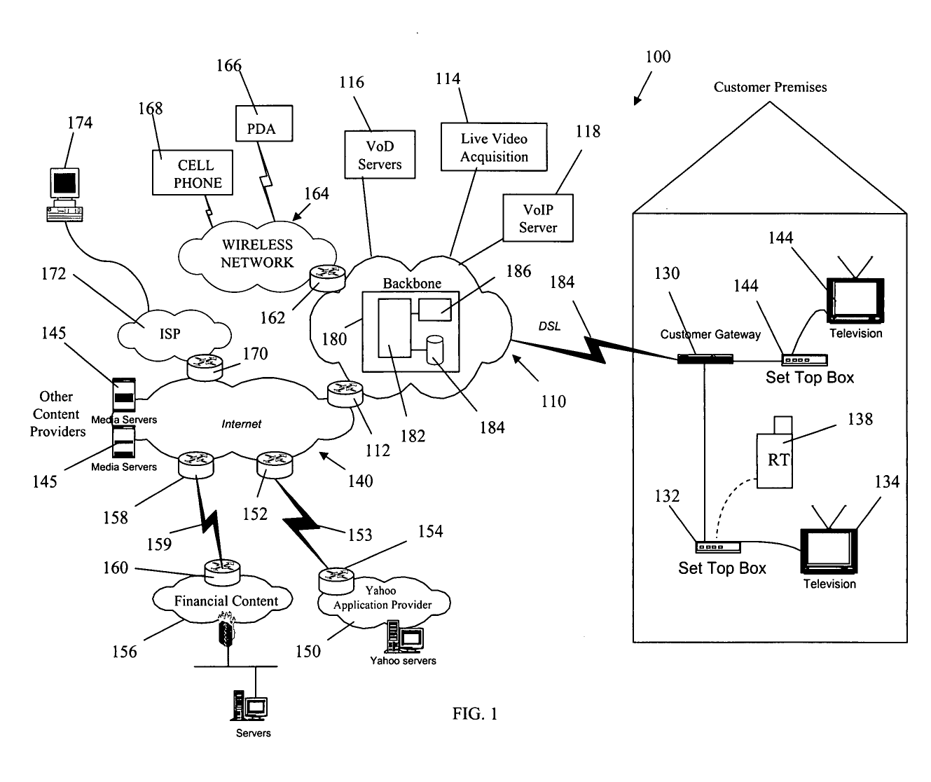

FIG. 1 shows an exemplary high-level functional diagram of a network 100 for providing IPTV services according to one embodiment of the present disclosure. The network 100 is shown to include a backbone 110 that may be coupled to the Internet 140 via one or more routers, such as a router 112. The backbone may provide at least one of IPTV services, cable service, and satellite services to a customer as well as content available through these services. Such content includes video content, audio content such as Voice over Internet Protocol (VoIP), and data content. The backbone also may include a variety of servers, routers and transport links. The backbone 110 is shown coupled to a live television content provider 114, that may include multiple television channels, such as commonly delivered over television networks. The backbone 110 also is shown to include Video-on-Demand (VoD) servers 116 that provide Video-on-Demand to customers. The backbone 110 is also shown to include a Voice over Internet Protocol (Voice over IP, or VoIP) server 118 that provides telephony service over a packet-switched network using an appropriate protocol, such as VoIP. The backbone 110 is shown coupled via a Digital Subscriber Line (DSL) 184 to a customer gateway, such as a modem 130, which may be coupled to one or more set-top-boxes (STBs), such as STB 132 and STB 142, that are connected to television (TV) sets 134 and 144, respectively. The backbone may additionally couple via a satellite connection to a satellite dish located at the customer location or via a cable connection to a cable STB. The STBs may act as control interfaces for the respective TV sets and may be accessed by remote control, such as remote control 138 accesses STB 132.

The backbone 110 is further shown coupled to a number of content providers over the Internet 140. For example, the backbone 110 is shown coupled to an Internet service provider (such as “Yahoo”) 150 via routers 152 and 154, and link 153; and a financial content provider 156 that may provide a financial service, such as customer investment portfolio information and/or enable a customer to order products and services from one or more vendors utilizing the STB 130, via routers 158 and 160, and link 159. Similarly, the backbone 110 may be coupled to or have access to any other partner content provider (generally designated by number 145), such as an interactive gaming service that enables a customer to play games against other players via a television, and a gaming service that enables a customer to bet online and settle accounts.

Still referring to FIG. 1, the backbone network 110 includes a system 180 that includes one or more servers 182, a database 184 that stores customer information, and a set of computer programs 186 which contain instructions that are executed by the server 182 to perform the methods and functions described herein. The customer information stored in the database 184 may include settings related to operations of one or more STBs at a customer location. These settings may include content recording capabilities, parental control of content available to viewers at a TV set, a list of favorite channels or most commonly visited channels (‘Favorites’) of a customer, as well as information related to broadband and voice service, including VoIP, and credit card numbers that may be charged for interactive activity by the customer, such as for buying merchandise, downloading videos, settling accounts, etc. In one aspect, the database 184 may store settings related to a STB, and these settings may be applied to content at the backbone 110. In another aspect, the STB may store the settings and the server 182 may receive the settings from the STB at a given time, such as on a scheduled basis, or upon request by the server 182 and store the settings in the database 184. In yet another aspect, settings for the STB may be shared between the database and the STB. The settings may be associated to the STB by an IP address, an identifier associated with the STB, or any other suitable identifier.

The backbone 110 is further shown coupled to a wireless network 164, such as a cellular network for cellular communication via a router 162. The wireless network 164 may be accessed by various remote devices enabled for wireless communication, such as cell phone 168 and Personal Digital Assistant (PDA) 166. The Internet 140 is further coupled to an exemplary network of an Internet Service Provider (ISP) 172 that may provide Internet service to a remote device, such as computer 174, which may be connected to the ISP 172 via router 170. A customer using these exemplary remote devices may access settings stored at database 184 and initialize or otherwise change settings. For example, a customer may initialize settings for an STB, such as setting up an account for parental controls, or make changes to settings, such as changing parental control settings. In another example, the customer may remotely program a STB, such as to record a program or to order a program from the VoD server 116. The system 180 also includes one or more computer programs 184 that are executed by the server 182 to perform the methods and functions described herein. The computer program may be distributed and reside in any suitable computer readable media accessible to the server.

Still referring to FIG. 1, content ratings associated with programs accessible to or embedded on a computer-readable medium located at the STB may also enable the parental control mechanism described herein. Parental controls may be used to block a viewer's access to video content such as regular TV programming and to purchases, such as a VoD or pay-per-view (PPV) programs. In a typical customer location where parental controls are used, a TV viewer may be assigned a viewer account that has an associated Personal Identification Number (PIN). The viewer may have several functions enabled through the account. For example, the viewer may be able to create a personal list of channels that are most often viewed (‘Favorites’). The viewer may be asked to enter a PIN number when interacting with the television set, such as when viewing certain content, or when purchasing video content from the network, such as VoD or PPV, or when purchasing an item, such as a ordering a book through a website, using the television set. Typically, one of the viewer accounts is given supervisory powers over the other viewer accounts and may be accessed by an account supervisor. The account supervisor may perform various functions, such as setting the PINs of the other viewers, controlling the video content that may be viewed by other viewers, monitoring the activities of other viewers, etc. The account supervisor may choose to set up categories of viewer accounts, such as ‘Teens’ and ‘Children,’ assign a viewer account to one of these categories, and supervise the activities of the viewer account indirectly through supervision of the category. Alternatively, the supervisor may choose to supervise a viewer account directly. Additionally, if a customer premise has more than one STB, the supervisor may set settings at each STB individually. In one example, using parental controls, a channel, show, or purchase may be blocked at a TV in one room, yet be available at a TV in another room.

Still referring to FIG. 1, a customer may create setting based on television content ratings. There are various rating systems available for use in parental control. One common rating system is provided by Motion Picture Association of America (MPAA) and uses the symbols G, PG, PG-13, R, NC-17, X to indicate recommended ages for viewing the content. Another common content rating system is the TV ratings system provided by the television industry and includes symbols such as TV-Y (for young children), TV-Y7 (directed toward older children), TV-G (directed towards a general audience), TV-PG (parental guidance suggested), TV-14 (parents strongly cautioned of strong material), and TV-MA (for mature audiences only). In addition, content having a rating of TV-PG, TV-14, and TV-MA may also have additional ratings, such as a V for violence, S for sexual content, L for language, or D for suggestive dialog, and FV for fantasy violence or cartoon violence.

One aspect of the present disclosure provides a computer-readable medium that affects settings related to the type of content viewable at a CPE device, such as a television set and content purchasable via an interaction between a viewer and the television via a controlling device, such as a STB. Settings may be applied towards content viewable at a CPE device, such as television programming from a network, VoD and pay-per-view (PPV) programming from a network, as well as the abovementioned content as stored at a DVR. In another aspect, the computer-readable medium may provide a program to block purchases that may be made via the STB, such as a book purchase. In another aspect, the settings, including parental controls, may be applied using variety of criteria to affect content. For example, a parental controls setting may be set to block video content according to the program (such as ‘CSI’), to block a channel (such as HBO), to block a type of content (such as programs that contain sexual content), etc. Any suitable ratings system available in the industry, such as MPAA ratings, V-chip ratings, game ratings, etc., may be used. Changes in settings may be made to individual viewer accounts, or to groups of viewer accounts. Also, a change may be made universally to all viewer accounts. The settings may also be set to unlock parental controls for all viewers for a period of time.

In another aspect, a monetary limit on items purchased via the television may be enforced over a time period, such as on weekly basis, a monthly basis, etc. In one example, purchases made within that time period may be made without entering a PIN number. However, once the purchase limit is reached, the viewer must enter a PIN number for approval of the purchase. Settings may be temporarily altered for a specifiable period of time without having to make changes to the current settings. For example, if parents are gone for a weekend they may increase the restriction level of parental controls for that period of time. Also, settings may be modified on behalf of the customer through a suitable notification method, such as a Customer Service Request (CSR) or through an Interactive Voice Recorder (IVR).

Another aspect of the present disclosure provides a computer-readable medium providing a ‘Favorites’ list that includes a list of channels that may be selected by a viewer from a main programming guide displaying most or all of the provided channels. The Favorites list generally includes those channels most frequently visited by a viewer and may be limited to a pre-determined maximum number of channels (i.e., 20 channels). Channels may include several content, such as programming, VoD, Internet, purchasing, and other channels. Multiple ‘Favorites’ lists may be provided to a STB or to a database at the network to address multiple viewers at common or separate TV sets. Additionally, a single ‘Favorites’ list may change in form between two TV sets with different parental control settings. In one aspect, the viewer may push a button on a remote control device to toggle between the main guide and the ‘Favorites’ list. If a channel is blocked from the main guide using parental control settings, the main guide may display all of the network channels except the blocked channels. Alternatively, the main guide may display all channels and change some aspect of the appearance of the name of the blocked channel to indicate the blocked status. For example, the name of the blocked channel may appear using a different shading or by using italics, etc. Any number of ways of altering the appearance may be used. In another aspect, restrictions made to the main programming guide transfer to a ‘Favorites’ listing, such that a channel blocked at the main programming guide is absent from the Favorites list. In another aspect, the backbone may provide the channel guide and the ‘Favorites’ list to any device such as a remote computer, a Personal Digital Assistant (PDA), a cellular phone, etc. Such provision may be via a web portal sent by the application provider 150. The customer may access the portal utilizing a logon and providing the PIN number or another identifier recognized by the backbone 110 or the provider 150. The customer may then change the ‘Favorites’ list or lists and also block or unblock a channel via the remote device.

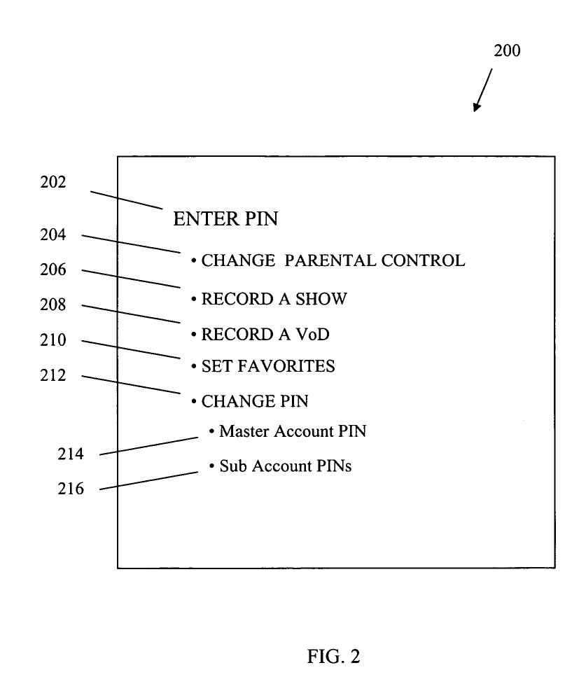

FIG. 2 illustrates an exemplary screenshot 200 displaying options available to a supervisor through an interface accessible by an STB or a remote device. The exemplary screen 200 includes an option to enter a PIN, change parental controls 204; record a show 206 such as a scheduled program, by setting channels and times or by selecting a program ID; record a VoD 208; set up or change a ‘Favorites’ list for a viewer account (i.e., a list of favorite channels of a viewer); change the PIN(s) 212 of one or more viewer accounts, including the master account 214 and the viewer accounts (sub accounts) 216. Changes to PINs may be made to a group or category of viewer accounts (i.e., ‘Teens,’ ‘Children’) or to an individual viewer account. Confirmation of the action of resetting a PIN may be sent to a designated email account. As an example, a user may select settings to record a program or a VoD. The settings may be set through the STB or by using a remote device to access the database 184. Thus, a user may set the STB to record a program or VoD via a cell phone, PDA, computer or any other suitable device, while the user is away from the TV set.

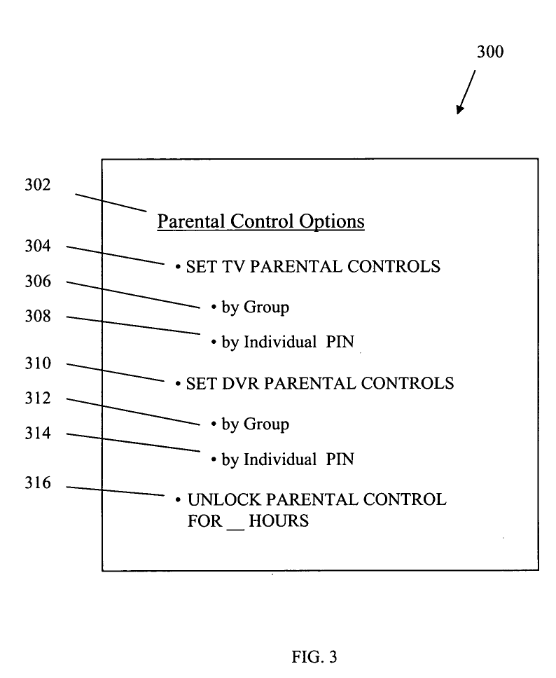

FIG. 3 illustrates an exemplary screenshot 300 for making changes to parental control settings. The screenshot is typically displayed once the ‘parent controls’ option (204) is selected from screen 200. The screen 300 includes a screen header 302; an option for setting a parental control for a television set 304; an option for setting parental controls related to Digital Video Recorder (DVR) content 310; and an option for unlocking parental controls for a specified amount of time 316. The option for setting parental controls on a television may be performed for a category of viewers 306 or for individual viewers 308. Parental controls may be set for multiple STBs so that video content that is restricted at one television set, such as a television in a living room area, may be enabled at another television set, such as a television in a bedroom area. Where a customer location has multiple DVRs, parental control settings may be assigned individually to each of the multiple DVRs by selecting the appropriate options. Parental controls may be applied to DVR content by group or category or by each individual account 314. A log of changes and any overrides (such as unlocking parental controls) may be recorded and made available to an email account.

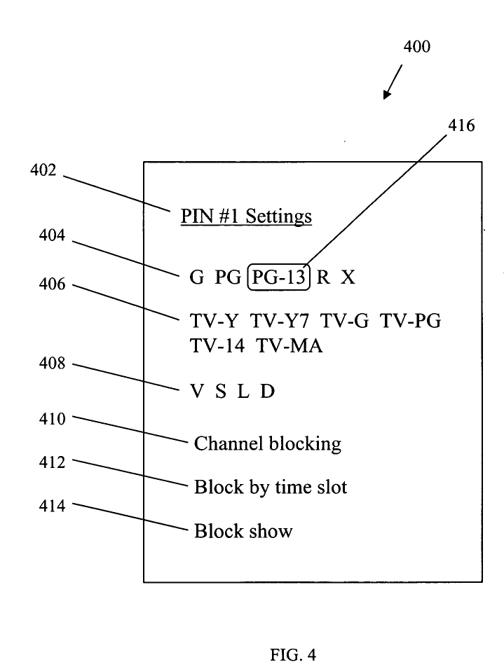

FIG. 4 shows a screenshot 400 of parental control settings of an individual account. The screenshot displays various ratings systems that may be used in connection with parental control settings. Some exemplary ratings systems are the MPAA ratings system 404, the television ratings system 406, and a ratings system identifying potentially objectionable content (V, S, L, D, FV) 408. A supervisor selects the rating level, thereby blocking content having that rating (or higher). In the exemplary screen 400, the supervisor has selected ‘PG-13’ 416 for the PIN #1 viewer, so that the PIN #1 viewer is restricted from viewing content rated at ‘PG-13’ (or higher). The supervisor may also select to block certain channels (i.e., HBO) from being viewed, or a certain show (i.e., Survivor) from being viewed. In another aspect, an account manager may restrict television viewing for a selected time period.

In the present disclosure, the settings of the STB are integrated into database 184 and may be accessed through a suitable portal, such as the Yahoo! portal. A viewer using a remote device, such as computer 174, may access the setting at the database via the remote device and make any desired changes. Once changes have been made, those changes may be communicated from the database to the STB. For example, a viewer is out shopping remembers that he would like to record a show on his DVR that is due to begin before he returns home. The viewer uses his cell phone (114 of FIG. 1) to establish a link to the backbone (110 of FIG. 1) via, for example, the screen illustrated in FIG. 2. By selecting an appropriate action (i.e., ‘Record a Show’ 206), he may be presented with a selection of programs from which to make a selection. Once he makes his selection, the changes may be stored to the database and transmitted to the STB. The settings at the STB are updated to reflect the viewer selection.

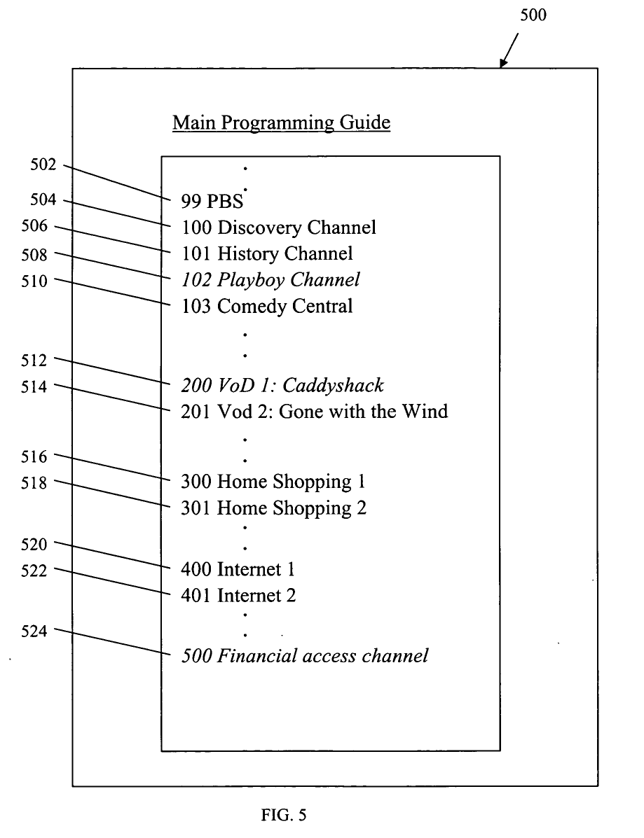

FIG. 5 illustrates an exemplary first list of names of channel, such as a main programming guide, in one aspect of the present disclosure. The exemplary main programming guide provides several channels available for viewing, including PBS 502, Discovery Channel 504, History Channel 506, Playboy Channel 508, and Comedy Central 510; several Video on Demand selections, such as Caddyshack 512 and Gone With the Wind 514; several Interactive shopping channels, such as Home Shopping Network 1 516 and Home Shopping Network 2 518; and several Internet connections such as Internet 1 520 and Internet 2 522. The exemplary main programming guide also provides a Financial Access Channel 524 dedicated to providing access to financial matters of the viewer, such as bill payments, bank statements, etc. It is understood that additional network services suitable for the medium and not explicitly mentioned herein may be added to the main programming guide by adding a channel. In the example of FIG. 5, the Playboy Channel 508, Caddyshack 512, and the Financial Access Channel 524 have been restricted from being viewed. Thus, the names of the Playboy Channel 508, Caddyshack 512, and the Financial Access Channel 524 appear visually different than the names of the other (viewable) channels. In the example, the appearance of the blocked channels is altered through the use of italics. However, any number of ways of altering the appearance may be used, including altering the color, the size, the shading, the font, etc., of the name. In an alternative aspect, the main programming guide may not show the names of the blocked channels at all.

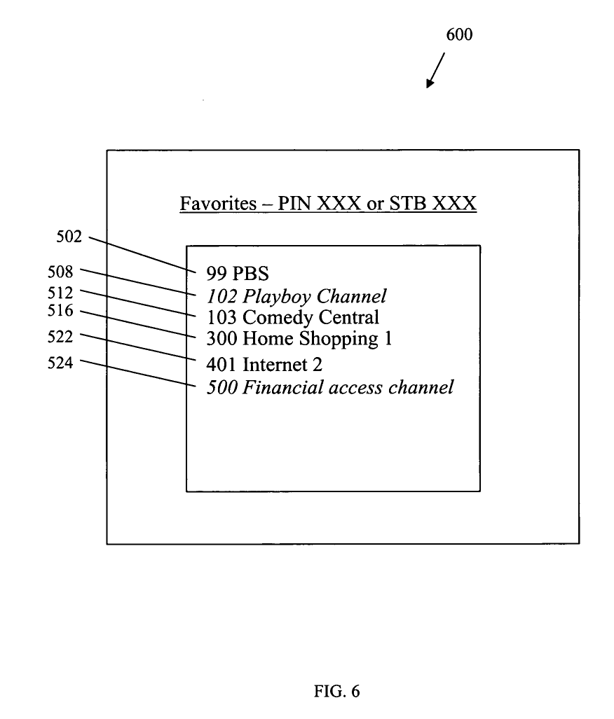

In the example of FIG. 5, blocked channels at one television set, such as in a living room, may be viewed at another television set, such as in the bedroom. FIG. 6 illustrates an exemplary Favorites listing shown at a television set at which channels are not blocked (bedroom). The Favorites list of FIG. 6 reflects the main programming guide as seen at the exemplary television set of the bedroom. For the purposes of illustration, the viewer has selected PBS 502, the Playboy Channel 508, Comedy Central 510, the Home Shopping Network 1 516, Internet 2 522, and Financial Access Channel 524 to appear in the Favorites list. Thus, these selections appear on the exemplary Favorites list of FIG. 6 that may be viewed in the unrestricted room (i.e., bedroom). These Favorites may be selected corresponding to a particular PIN XXX or an STB XXX.

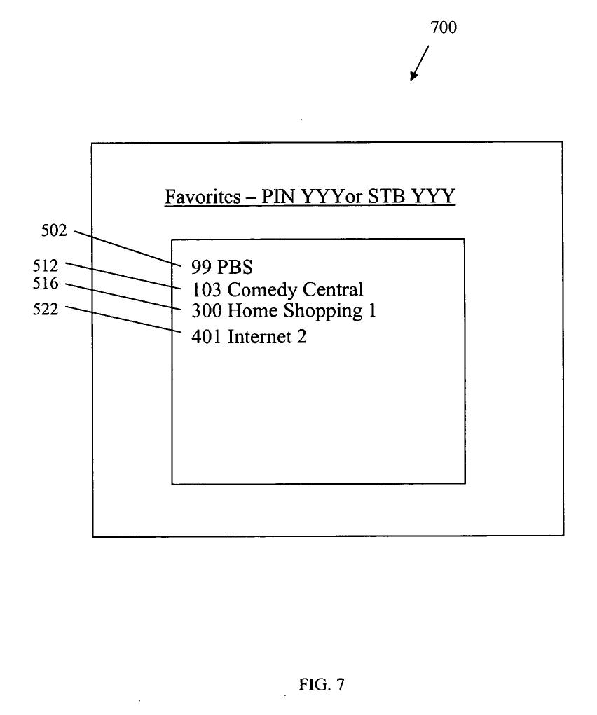

FIG. 7 shows the same Favorites list of FIG. 6 as viewed from the television set of the living room at which parental control settings block certain channels. The blocked channels (i.e., Playboy Channel, Caddyshack, and Financial Access Channel) do not appear on the Favorites list when the list is accessed from the television set in the living room. The viewer sees PBS 502, Comedy Central 512, Home Shopping Network 1 516 and Internet 2 522 at the living room set. These favorites maybe selected corresponding to a particular PIN YYY or STB YYY. Further, programming guide, such as shown in FIG. 5 may be customized for each PIN or STB.

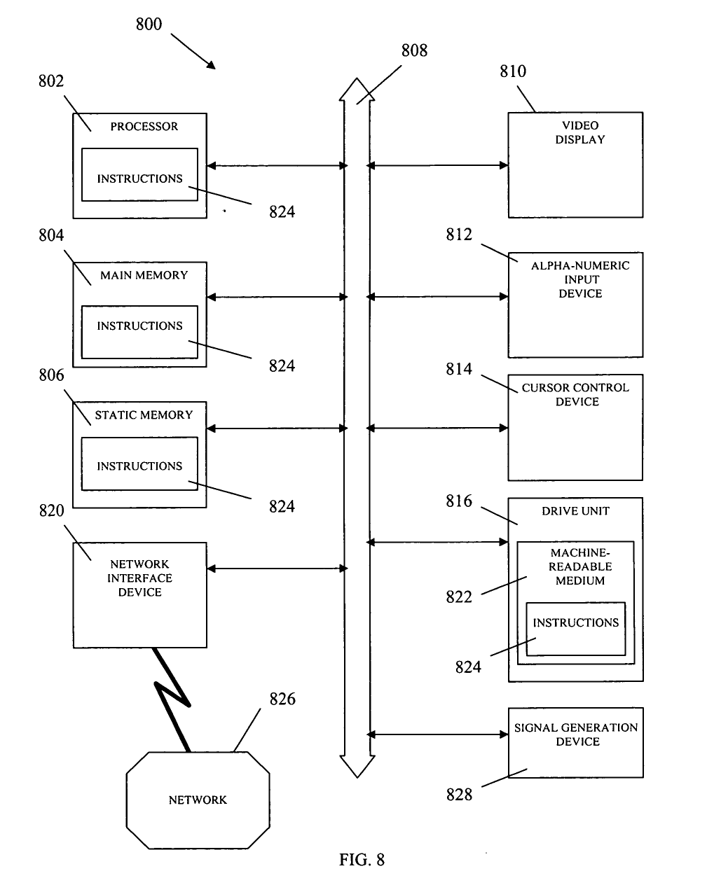

FIG. 8 is a diagrammatic representation of a machine in the form of a computer system 800 within which a set of instructions, when executed, may cause the machine to perform any one or more of the methodologies discussed herein. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a set-top box (STB), a Personal Digital Assistant (PDA), a cellular telephone, a mobile device, a palmtop computer, a laptop computer, a desktop computer, a personal digital assistant, a communications device, a wireless telephone, a land-line telephone, a control system, a camera, a scanner, a facsimile machine, a printer, a pager, a personal trusted device, a web appliance, a network router, switch or bridge, or any machine capable of executing a set of instructions (sequential or otherwise) that specify actions to be taken by that machine. It will be understood that a device of the present invention includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 800 may include a processor 802 (e.g., a central processing unit (CPU), a graphics processing unit (GPU), or both), a main memory 804 and a static memory 806, which communicate with each other via a bus 808. The computer system 800 may further include a video display unit 810 (e.g., a liquid crystal display (LCD), a flat panel, a solid state display, or a cathode ray tube (CRT)). The computer system 800 may include an input device 812 (e.g., a keyboard), a cursor control device 814 (e.g., a mouse), a disk drive unit 816, a signal generation device 818 (e.g., a speaker or remote control) and a network interface device 820.

The disk drive unit 816 may include a machine-readable medium 822 on which is stored one or more sets of instructions (e.g., software 824) embodying any one or more of the methodologies or functions described herein, including those methods illustrated in herein above. The instructions 824 may also reside, completely or at least partially, within the main memory 804, the static memory 806, and/or within the processor 802 during execution thereof by the computer system 800. The main memory 804 and the processor 802 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present invention, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present invention contemplates a machine readable medium containing instructions 824, or that which receives and executes instructions 824 from a propagated signal so that a device connected to a network environment 826 can send or receive voice, video or data, and to communicate over the network 826 using the instructions 824. The instructions 824 may further be transmitted or received over a network 826 via the network interface device 820.

While the machine-readable medium 822 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the invention is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A computer-readable medium accessible to a processor for executing instructions contained in a computer program embedded in the computer readable medium, the computer program comprising:
instructions to provide a first list of channels for display on a television set;
instructions to create a second list of channels, at least in part from the first list; and
instructions to switch between the first list and the second list for viewing the lists on the television set.

2. The computer-readable medium of claim 1, wherein the computer program further comprises:
instructions to block a channel from appearing on one of the first list and second list in response to an input from a customer device.

3. The computer-readable medium of claim 1, wherein the computer program further comprises:
instructions to alter appearance of a blocked channel.

4. The computer-readable medium of claim 2, wherein the computer program further comprises:
instructions to automatically block a channel on the second list that is blocked on the first list.

5. The computer-readable medium of claim 2, wherein the customer device is one of a set top box (STB), personal digital assistant (PDA), a cellular telephone and a computer.

6. The computer-readable medium of claim 1, wherein the first list comprises channels selected from a list consisting of scheduled programming, Video on Demand (VOD), Internet access, Pay Per View (PPV) programs, and channels for interactive transactions.

7. A method for providing television services, comprising:
providing a first list of channels to a customer device for viewing the channels on a television set;
creating a second list of channels selected at least in part from the first list; and
switching between the first list and the second list for viewing on a television set in response to an input from the customer device.

8. The method of claim 7 further comprising blocking a channel on one of the first list and the second list from viewing on a television set in response to an input from the customer device.

9. The method of claim 7 further comprising affecting appearance of a selected channel in response to an input for blocking the selected channel.

10. The method of claim 7 wherein the customer device is one of a CPE, a cellular phone, PDA, and computer.

11. The method of claim 7 further comprising blocking a channel on the second list that is blocked on the first list.

12. The method of claim 7 further comprising providing a web portal to a customer device for blocking a channel from one of the first and second lists.

13. An apparatus for use with a television set, comprising:
a computer readable medium accessible to a processor for executing instructions contained in a computer program embedded in the computer readable medium, the computer program comprising:
instructions to receive a first list of channels for display on the television set;
instructions to receive input for selecting a second list of channels from the first list of channels;
instructions to display the second list of channels on the television set; and
instructions to switch between display of the first list and second list of channels on the television set.

14. The apparatus of claim 13, wherein the computer program further comprises:
instructions to block a selected channel on the first list in response to an input.

15. The apparatus of claim 14, wherein the computer program further comprises:
instructions to automatically block the selected channel on the second list.

16. The apparatus of claim 13 further comprising: a remote device operatively coupled to the apparatus that provides input for selecting the second list of channels and input to switch between the display of the first and second lists of channel.

17. The apparatus of claim 13, wherein the computer program further comprises instructions to block a channel on the second list in response to an input from a remote device associate with the apparatus.

18. The apparatus of claim 1, wherein the selected channel is selected from a group consisting of a channels grouped by selected categories, video-on-demand channel, pay-per-view channel, interactive channel for purchasing a product, and interactive channel that enables data or voice communication over the internet.

19. The apparatus of claim 13 further comprising an interface operatively coupled to a communications network for receiving content and an interface operatively coupled to the television set for displaying the content on the television set.

20. The apparatus of claim 13, wherein the computer program further comprises instructions to block a channel upon receiving a customer identifier.
